(19) United States
(12) Patent Application Publication
(10) Pub. No.: US 2026/0204801 A1
(43) Pub. Date: Jul. 16, 2026

(54) DEPLOYABLE ANTENNA REFLECTOR

(71) Applicant: United States of America as represented by the Administrator of NASA, Washington, DC (US)

(72) Inventors: Juan M. Fernandez, Norfolk, VA (US); Andrew F. Paddock, Newport News, VA (US); Kevin DeMarco, Yorktown, VA (US)

(21) Appl. No.: 19/428,895

(22) Filed: Dec. 22, 2025

Related U.S. Application Data
(62) Division of application No. 18/606,423, filed on Mar. 15, 2024, now Pat. No. 12,548,915.
(60) Provisional application No. 63/452,712, filed on Mar. 17, 2023.
(60) Provisional application No. 63/452,713, filed on Mar. 17, 2023.

(51) Int. Cl. H01Q 15/20; H01Q 1/28; H01Q 15/14; H01Q 15/16

(52) U.S. Cl. CPC H01Q 15/20; H01Q 1/288; H01Q 15/148; H01Q 15/16

(57) ABSTRACT

Self-deploying reflector array architectures include stacked multiple panels attached to a central panel by sets of heat actuated flexible hinges on their non-functional sides create surface of revolution, cylindrical and flat reflector arrays in accordance with panel curvature. Robotic in-space assembly of multiple smaller arrays allows for creation of reflector array of 10 or more meters to support S-band and above RF (≥2 GHz) transmission.

### CROSS-REFERENCE TO RELATED PATENT APPLICATION(S)

This patent application is a divisional of U.S. patent application Ser. No. 18/606,423, filed on Mar. 15, 2024, which claims priority to U.S. Provisional Application No. 63/452,712, filed on Mar. 17, 2023, entitled Shape Memory Polymer Composite Substrate and priority to U.S. Provisional Application No. 63/452,713 filed on Mar. 17, 2023, the contents of each of which are hereby incorporated by reference in their entirety.

The patent application also cross-references commonly owned U.S. Pat. No. 9,796,159 entitled Electric Field Activated Shape Memory Polymer Composite; U.S. Pat. No. 11,267,224 entitled Method for Preparing and Electrically-Activated Shape Memory Polymer Composite; and U.S. patent application Ser. No. 18/238,137 entitled Composite Deployable Structure; U.S. Provisional Application No. 63/401,394, filed on Aug. 26, 2022; U.S. Provisional Application No. 63/452,752, filed on Mar. 17, 2023; U.S. Provisional Application No. 63/455,468, filed on Mar. 29, 2023; U.S. patent application Ser. No. 18/605,929 (LAR 20352-1) entitled Shape Memory Polymer Composite Substrate, and U.S. patent application Ser. No. 18/606,292 (LAR 20513-1) entitled Deployable Antenna Reflectors Array Formed of Multiple Connected Gores, each of which is incorporated herein by reference in its entirety.

### STATEMENT REGARDING FEDERALLY SPONSORED RESEARCH OR DEVELOPMENT

The invention described herein was made by employees of the United States Government and may be manufactured and used by or for the Government of the United States of America for governmental purposes without the payment of any royalties thereon or therefore.

### BACKGROUND OF THE EMBODIMENTS

Antennas are the cornerstone of high data rate communications and transmission for Earth missions and deep-space communications, both from space and from moon/planetary surfaces. Deploying operational antennas into space in an efficient manner remains a challenge. In order to meet the increasing demand for high-throughput satellited (HTS) antennas that can operate at higher frequencies, larger reflector configurations are required.

Conventional, fixed, solid surface antenna radiofrequency (RF) reflectors up to 4 meters in diameter are available and can target Ka-Band or above RF transmission. Deployable versions with rigid panels up to 10 meters in diameter have been explored, but present mechanical complexities to stow/deploy due to volume and mass.

Deformable versions using thin-shell composite reflective surface construction, such as that described in U.S. Pat. No. 6,344,835, are possible but have size limitations, e.g., less than 10 m diameter, due to surface accuracy requiring deep backbones or perimeter ring structures to scale up. Mesh reflector antennas are currently the only technical approach to realize effectively deployable reflectors larger than 10 meters for Ka-Band RF transmission but have limitations for higher RF bands due to faceting inherent to the mesh architecture and not having a solid surface. The RF energy at higher frequencies would leak through the gaps in the mesh. It is understood that frequencies above 60-70 GHz require a solid, highly accurate surface.

For even larger reflector needs greater than 10-20 meters, in-space assembly (ISA) is a considered approach. Current concepts like the Space Infrastructure Dexterous Robot (SPIDER) rely on robotic arm to assemble many individual panels that do not package well, and require complicated techniques for joining and multiple operations, increasing cost and risk. The discontinued SPIDER experiment by Maxar on NASA's On-orbit Servicing, Assembly and Manufacturing (OSAM-1) mission was planned to robotically assemble a 3-m scale reflector from seven 1-m rigid segments fixed to the spacecraft, but the rigid elements do not package efficiently inside the rocket fairing and must be assembled by a large robotic arm using overly complicated techniques.

There remains a need for improved materials, configurations and processes for efficient self-deployment of antenna reflectors of varying sizes in space to support S-band and above RF (≥2 GHz).

### BRIEF SUMMARY OF THE EMBODIMENTS

In a first exemplary embodiment, an antenna reflector array having at least a stowed position and a deployed position includes: multiple panels and a central panel, each of the multiple and central panels including a functional side and a non-functional side, wherein in the stowed position, the multiple hexagonal and central panels are in a compact configuration; multiple sets of heat actuated flexible hinges formed of a shape memory composite (“SMC”) substrate, each of the multiple sets of flexible hinges being connected at a first end thereof to a non-functional side of one of the multiple panels and at a second end thereof to the non-functional side of the central panel, the heat actuated flexible hinges being controllable between a first shape and a second shape; and further wherein, when each set of heat actuated flexible hinges changes from the first shape to the second shape, a panel connected thereto is moved from a first position to a second position.

In a second exemplary embodiment, an antenna reflector array having at least a stowed position and a deployed position includes: multiple panels and a central panel, each of the multiple and central panels including a functional side and a non-functional side, wherein in the stowed position, the multiple hexagonal and central panels are in a concentrically stacked configuration; multiple sets of heat actuated flexible hinges, each of the multiple sets of flexible hinges being connected at a first end thereof to a non-functional side of one of the multiple panels and at a second end thereof to the non-functional side of the central panel, the heat actuated flexible hinges being controllable between a first shape and a second shape, and further wherein, when each set of heat actuated flexible hinges changes from the first shape to the second shape, a panel connected thereto is moved from a first position to a second position; and multiple closing mechanisms, each of the multiple closing mechanisms being movably attached to a set of heat actuated flexible hinges and an associated one of the multiple panels, wherein each of the multiple closing mechanisms is triggered when its associated panel is in the second position, the multiple closing mechanisms moving its associated panel to a third position responsive to the trigger, the third position resulting in the final deployed position.

In a third exemplary embodiment, a process for assembling multiple individual reflector sub-arrays into a consolidated reflector array includes: deploying multiple individual reflector sub-arrays from their stowed positions, each of the multiple individual reflector sub-arrays including multiple connected panels and a connecting boom for maintaining connection with a spacecraft, wherein deploying an individual reflector sub-array includes activating one or more hinges connected between each side panel and a central panel of the subarray on the non-functional surfaces thereof to deploy each of the side panels from their stowed positions; robotically connecting each of the multiple deployed individual sub-arrays to a designated central deployed individual sub-array, wherein the boom of each of the multiple deployed individual sub-arrays is robotically attached to a different connection point on the central deployed individual sub-array; and further wherein at least one additional securing mechanism is robotically attached between at least one panel of each of the multiple deployed individual sub-arrays and a panel of the designated central deployed individual sub-array

These and other features, advantages, and objects of the present embodiments will be further understood and appreciated by those skilled in the art by reference to the following specification, claims, and appended drawings.

### BRIEF DESCRIPTION OF THE SEVERAL VIEWS OF THE DRAWINGS

Example embodiments will become more fully understood from the detailed description given herein below and the accompanying drawings, wherein like elements are represented by like reference characters, which are given by way of illustration only and thus are not limitative of the example embodiments herein.

FIG. 1 illustrates a first stacked configuration of a seven-panel reflector array in accordance with one or more embodiments herein;

FIGS. 2a and 2b illustrate the stacked array of FIG. 1 in various stages of deployment in accordance with one or more embodiments herein;

FIGS. 3a, 3b, 3c and 3d illustrate a first exemplary hinge formed from flexible shape memory composite (SMC) in heat/electrically and/or mechanically controlled stages of shape changes in accordance with one or more embodiments herein;

FIGS. 4a, 4b, 4c illustrate a second exemplary hinge formed from flexible shape memory composite (SMC) in heat/electrically and/or mechanically controlled stages of shape changes in accordance with one or more embodiments herein;

FIGS. 5a, 5b, 5c illustrate an exemplary two-panel configuration with flexible hinge in accordance with one or more embodiments herein;

FIGS. 6a, 6b, 6c, 6d, 6e, 6f, 6g, 6h and 6i illustrate various views and features of the underside of a reflector array during deployment in accordance with one or more embodiments herein;

FIG. 7 provides an isometric view of a reflector array midway through deployment in accordance with one or more embodiments herein;

FIGS. 8a and 8b show top view (FIG. 8a) of fully deployed reflector array and bottom view (FIG. 8b) of fully deployed reflector array in accordance with one or more embodiments herein;

FIGS. 9a, 9b, 9c, 9d, 9e, 9f, 9g, 9h, 9i, 9j, 9k illustrate a second stacked configuration of a seven-panel reflector array in accordance with one or more embodiments herein; and

FIGS. 10a, 10b, 10c and 10d illustrate and in-space assembly process for constructing a larger reflector from multiple deployed reflector sub-arrays in accordance with one or more embodiments herein; and

FIGS. 11a, 11b, and 11c illustrate alternative configurations to the panel stacking configuration of FIG. 1.

### DETAILED DESCRIPTION

It is to be understood that the invention may assume various alternative orientations and step sequences, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

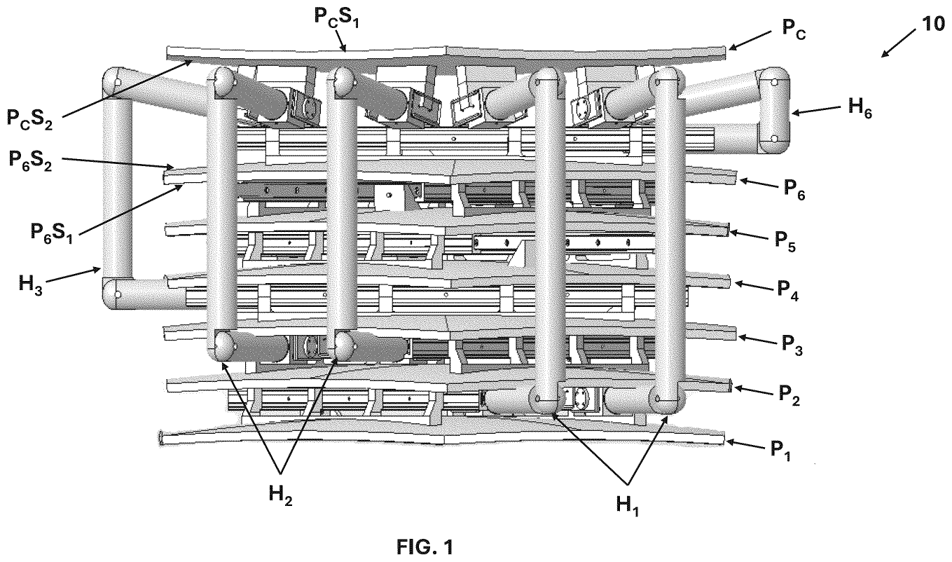

FIG. 1 presents a first configuration of a seven-panel reflector array 10 in a stowed, concentrically stacked configuration. Rigid hexagonal panels one through six, P₁, P₂, P₃, P₄, P₅, P₆, are attached to the central panel P_{C}, by individual sets of two composite tubular hinges H₁, H₂, H₃, H₄ (not shown), H₅ (not shown), H₆. Panels P₁, P₂, P₃, P₄, P₅, P₆ are constructed using a sandwich approach to yield a high specific stiffness construction. By way of example, the panel core can be made from carbon foam (CFOAM 30®) sealed with ES-215 epoxy resin mixed with IHG hardener that is used in high temperature composite tooling or a carbon fiber reinforced plastic (CFRP) honeycomb sheet, both of which provide a low coefficient of thermal expansion (CTE) material. CFRP face sheets can be co-cured directly onto the cores and bonded in a single step using a thin EA9696 epoxy film or similar adhesive. The face sheet is a four-ply balanced and symmetric plain weave laminate. Additional details may be found in the conference manuscript to Juan M. Fernandez et al., SEGMENTED HEXAGONAL ANTENNA REFLECTOR CONCENTRICALLY STACKED USING SHAPE MEMORY COMPOSITE TUBULAR HINGES, 41^{st} ESA Antenna Workshop on Large Deployable Antennas, 25-28 Sep. 2023 at ESA-ESTEC in Noordwijk, The Netherlands, the contents of which is incorporated herein by reference in its entirety.

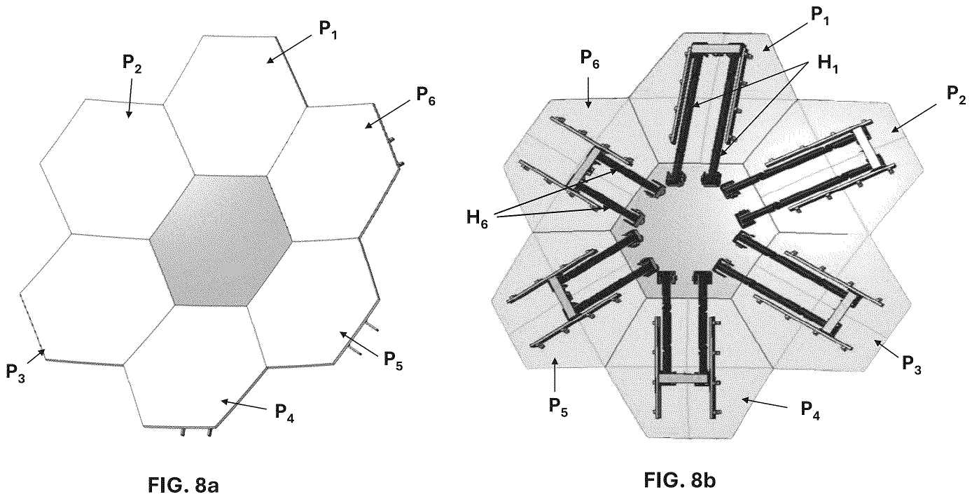

In the embodiment shown in FIG. 1, all panels are double curved. Further to the configuration of FIG. 1, when in the stowed or stacked position, the central panel P_{C}'s concave, reflective side P_{C}S₁ faces away—or opposite—from the functional, reflective sides, e.g., P₆S₁, of panels one through six. The non-functional, non-reflective sides of central panel P_{C}, P_{c}S₂ and P₆, P₆S₂ face each other. While the illustrated panel shape is hexagonal, other panels shapes are possible, such as squares or pentagons. In the deployed position, all concave, functional, reflective sides of P_{C}, P₁, P₂, P₃, P₄, P₅, P₆ face the same direction to create a parabolic reflector (see FIG. 8a). In alternatives embodiments, all panels may be doubly curved to form any desired surface of revolution (spherical, paraboloid, etc.) in the deployed state, single curved to form a cylindrical surface in the deployed state, or flat to form a flat surface in the deployed state. Hinges H₁, H₂, H₃, H₄, H₅, and H₆ are attached to the non-functional, non-reflective sides of panels P_{C}, P₁, P₂, P₃, P₄, P₅, P₆.

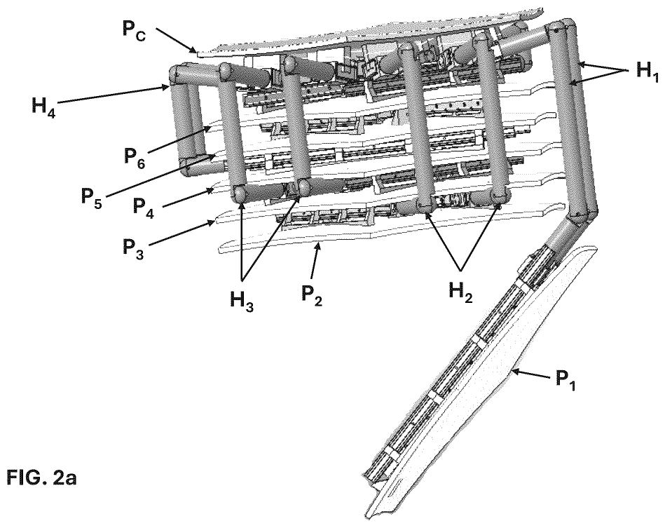

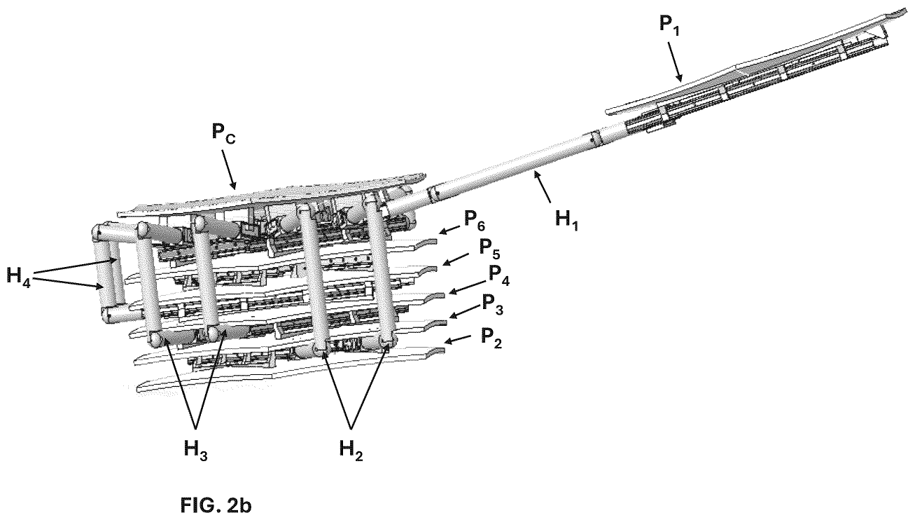

FIGS. 2a and 2b present array 10 in different stages of the reflector deployment process. Specifically, FIG. 2a shows the first panel P₁ at a first interim point of deployment, wherein the two composite hinges in set H₁ mid-process of straightening. And FIG. 2b shows the first panel P₁ at a second interim point of deployment, wherein the two composite hinges in set H₁ are straight.

Composite hinges H₁, H₂, H₃, H₄, H₅, and H₆ are formed from a flexible shape memory composite (“SMC”) substrate such as that described in co-owned U.S. patent application Ser. No. 18/605,929(LAR-20532-1) and U.S. Provisional Ser. No. 63/452,712 which are incorporated herein by reference in their entireties. Components formed from SMC can be programmed into a temporary shape through applied force and internal heating. In the programmed shape, the deformed structure is in a frozen state remaining dormant without external constraints. Upon heating once more, the substrate will return slowly (several to tens of seconds) to the original shape.

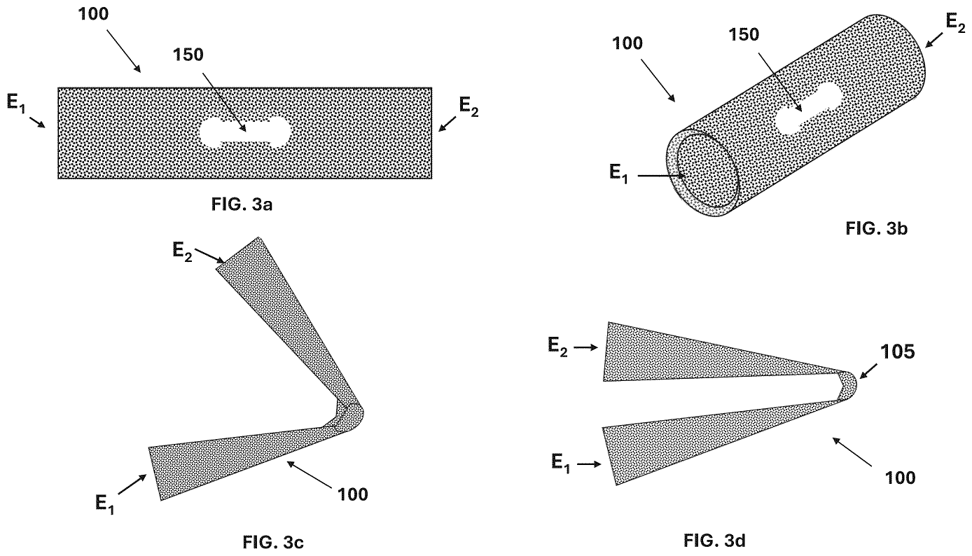

Referring to FIGS. 3a, 3b, 3c and 3d, a first exemplary hinge 100 formed from SMC is originally in the tubular shape shown in FIGS. 3a, 3b and has been programmed into the temporary, frozen shape shown in FIG. 3d. Upon heat (actuating) being applied to one or more heaters (not shown) embedded within or on the surface of the hinge 100 while in its pre-programmed frozen shape (FIG. 3d), hinge 100 unfolds, passing through intermediate shapes (e.g., FIG. 3c) to its original shape (FIGS. 3a, 3b). Hinge 100 is in a tube configuration, with a cutout portion 150 on diametrically opposing sides of the tube. Hinge 100 includes first and second ends E₁ and E₂.

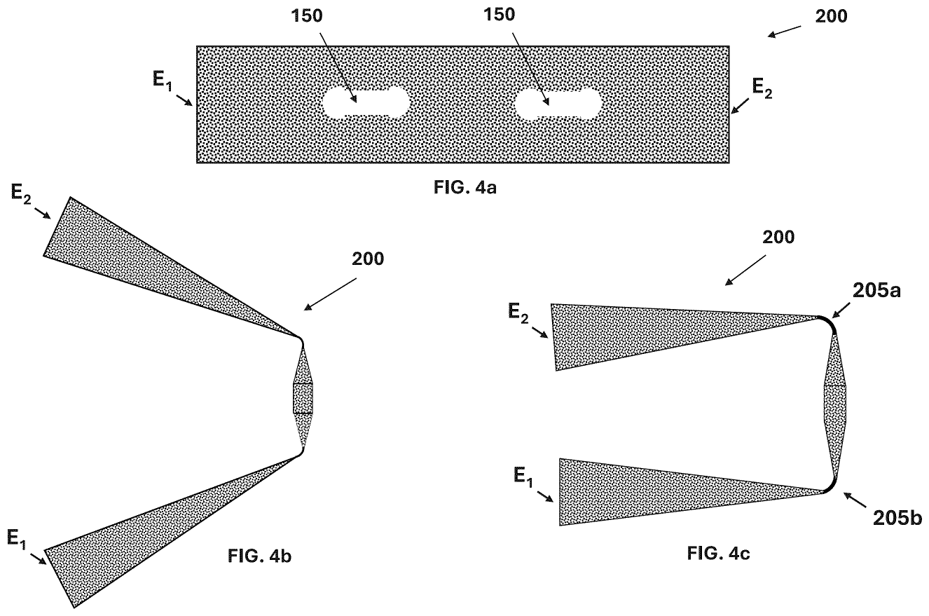

Similar to the first exemplary hinge 100, a second exemplary hinge 200 (FIGS. 4a, 4b, 4c) is identical to hinge 100 in all respects except hinge 200 includes two cutout portions 150, two on each diametrically opposite side, which facilitate two hinging points 205a and 205b during actuation (as compared to single hinge point 105 in hinge 100). The cutouts of exemplary hinges 100 and 200 are diametrically opposite dog bone-shapes that enable localized pinching and folding the hinge without damage. Dog bone slots are preferred over straight slots with a constant slot width to increase deployed stiffness and minimize the risk of hinge snap back and deployment anomaly. Other optimal cutout shapes are possible depending on the hinge design.

As described in co-owned U.S. patent application Ser. No. 18/605,929(LAR-20532-1) SMC hinges used in the present embodiments may also include on or more layers of heat spreading material to assist with distribution of applied heat, as well as sensors, such as strain and temperature sensors and a microprocessor for implementing a monitoring and feedback process.

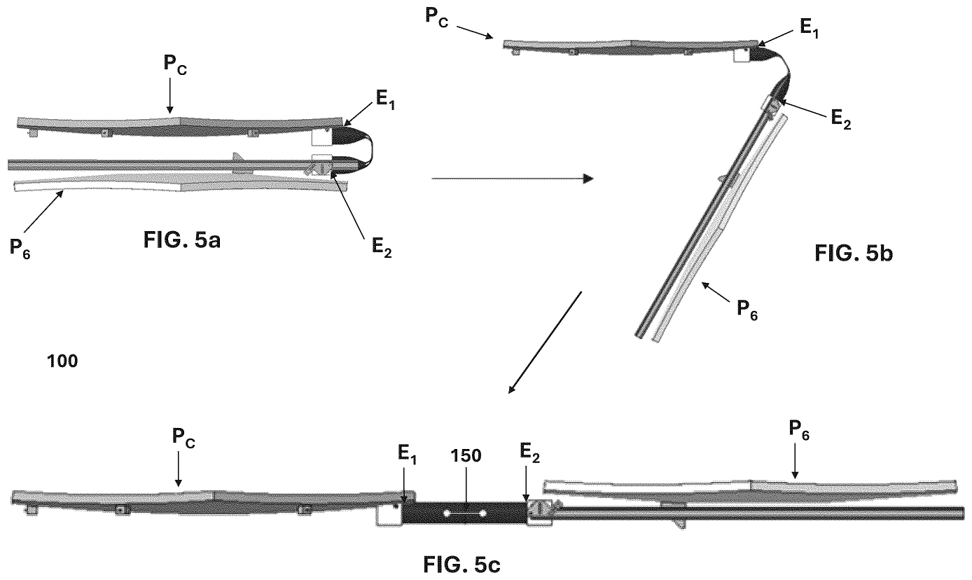

As illustrated in FIGS. 5a, 5b and 5c, at least a first hinge 100 may be used to secure panel P₆ to the central panel P_{C}. Panel P₆ is stowed when the hinge is in its programmed temporary shape (FIG. 5a) and opens when the hinge is heat actuated through its one or more heaters, passing through various intermediate shapes (FIG. 5b) until panel P₆ is fully unfolded when hinge 100 is at its original shape (FIG. 5c). For all other panels, P₁, P₂, P₃, P₄, P₅, hinge 200 is used as these panels are farther from the central panel P_{c} and the dual hinge points 205a, 205b are needed to complete the approximately 180-degree unfolding.

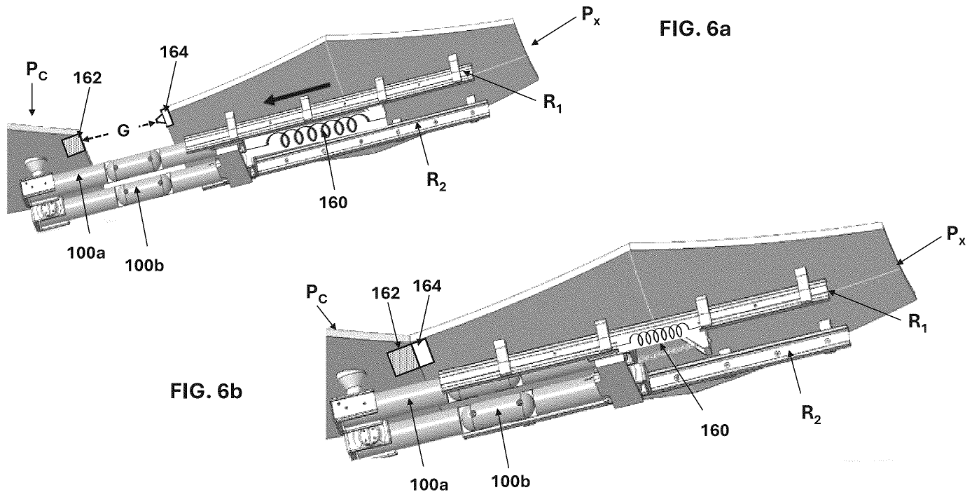

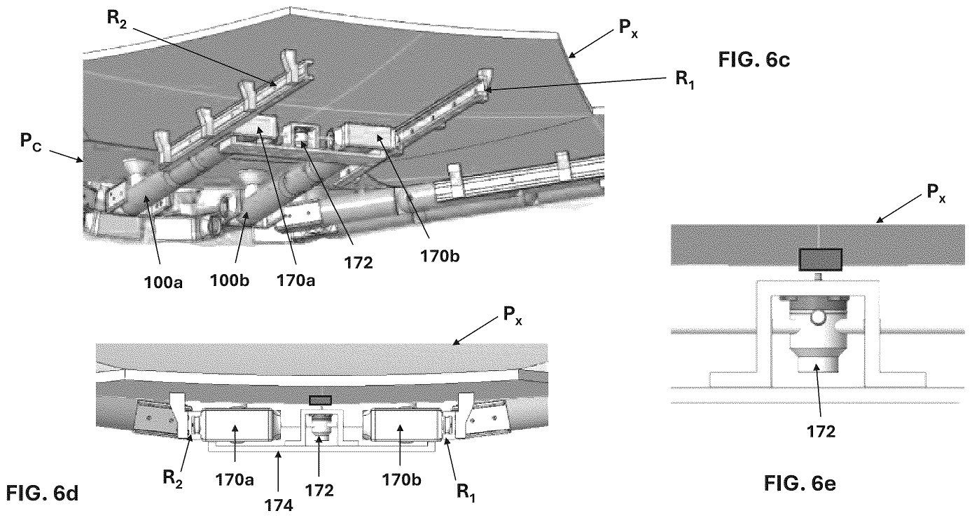

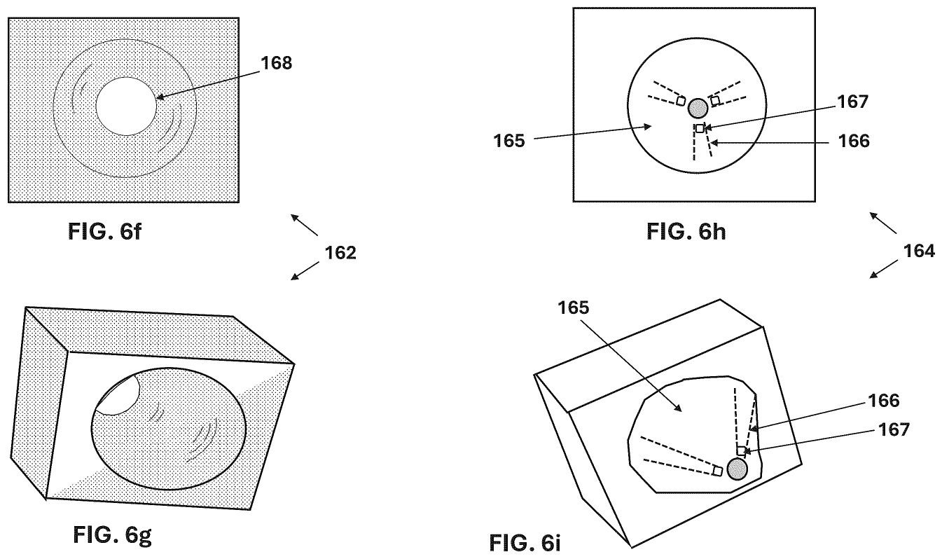

In a preferred embodiment, each panel Pₓ is connected to the central panel P_{C} by two parallel hinges, 100a and 100b as shown in FIGS. 6a and 6b. FIG. 6a is an isometric view of the underside of FIG. 5c and shows additional features of the reflector array. More particularly, FIG. 6a shows guide rails R₁ and R₂ and spring 160 which facilitate closing the remaining gap G between panels Pₓ and P_{C} once hinge 100 has finished unfolding. FIG. 6b shows the panels with no gap therebetween. Also shown are cup 162 and cone 164 mating elements which further align and secure the panels together. While only one set of mating elements are shown in the FIGS., a second set is located on the opposite side of the hinges.

Additional alignment feature pairs can be used. FIGS. 6f, 6g, 6h and 6i provide various views and features of the exemplary mating elements 162 and cone 164. In FIGS. 6h and 6i, cone 164 includes protruding cone portion 165 which includes press fit portions 166 located at approximately 120, 240 and 360 degree locations on cone portion 165. At the end of each press fit portion 166 is a clip protrusion 167 for clicking into place within a female receiver portion 168 in cup 162.

FIGS. 6c, 6d and 6e provide additional views of the guide rails R₁ and R₂ and the hold-down release mechanism 172 located on each panel Pₓ. Mechanism 172 fixes hinge end fittings 170a, 170b to the panel Pₓ when held down. When released, spring 160 is triggered and the spring force (constant force spring or tension spring) act approximately along the tubular hinge axis when the hinges are deployed to close the gap G by translating the hinge end fittings 170a, 170b fixed to trolley 174 along the guide rails R₁ and R₂. The hold-down release mechanism 172 can take the form of, for example, a Frangibolt or a pin puller.

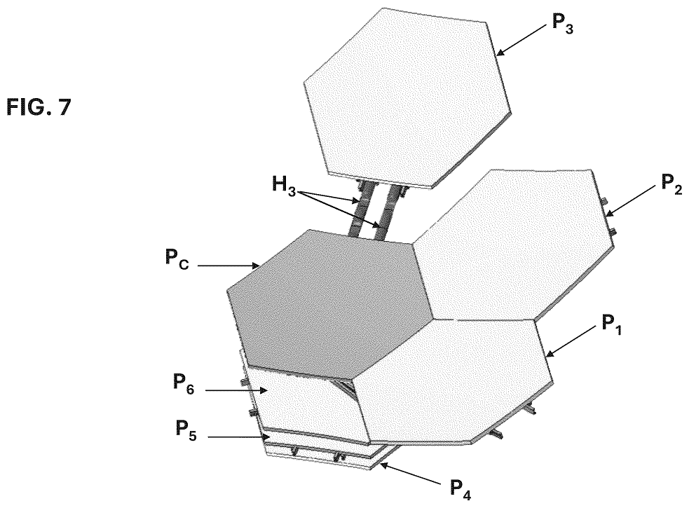

FIG. 7 provides a top view of the reflector array midway through deployment. As shown, panels P₁ and P₂ are deployed and in place, panel P₃ is partially deployed and panels P₄, P₅ and P₂ are awaiting deployment, in order.

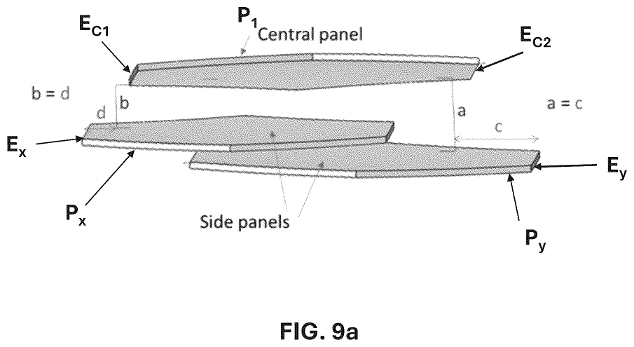

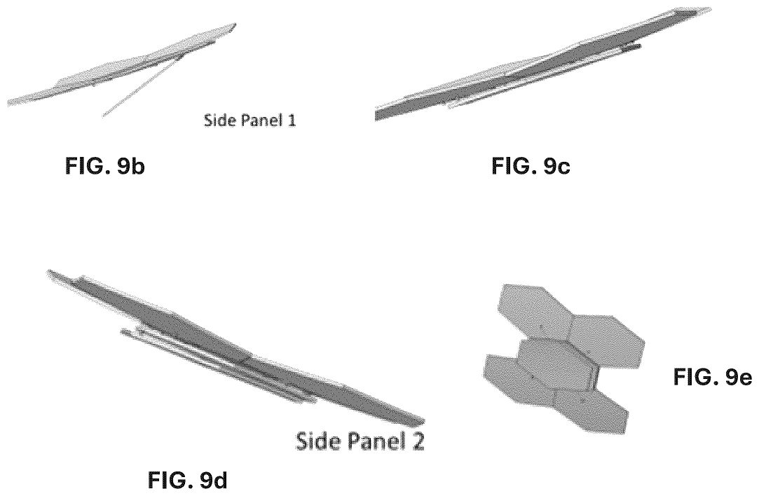

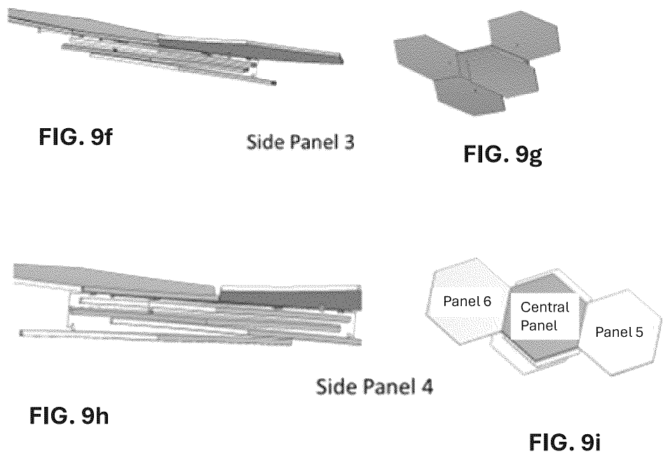

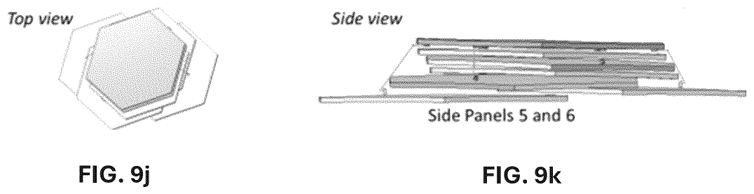

FIGS. 9a and 9b show top view (FIG. 9a) of fully deployed reflector array and bottom view (FIG. 9b) of fully deployed reflector array. In FIG. 9b, note the different lengths of the pairs of hinges. The panel P₁, which is furthest from the central panel P_{C} in the stowed stack (see FIG. 1), has the longest hinges H₁, with hinges decreasing in size moving up the stowed stack to shortest hinges H₆ on P₆. When deployed the hinges form a backbone support structure on the non-functional, non-reflective side that provides out-of-plane stiffness to the reflector assembly. Without the hinges, the seam line(s) of the assembly would behave like a hinge in itself.

FIGS. 9a, 9b, 9c, 9d, 9e, 9f, 9g, 9h, 9i, 9j, 9k illustrate a second stacked configuration of a seven-panel reflector array wherein the panels are stacked in a offset or staggered configuration such that each panel directly aligns with the central panel and neighboring panels when its respective hinges are unfolded. The lateral offset between each panel in the stowed state is designed such that when the pairs of tubular SMC hinges actuate they already mate the pairs of panel edges and there is no need for a secondary mechanism to close a gap between the central and neighboring panels and the newly unfolded panel as is required in the first concentrically stacked configuration describe above with respect to FIG. 1 et seq. Accordingly, while the concentric case provides an axisymmetric stacked configuration that is more volumetrically efficient, it is a heavier and more complex configuration than the offset approach of FIG. 9a et seq. due to the need for the use of the secondary closing mechanisms. In order to achieve direct alignment of each side panel with the central panel during deployment, the offset distance Dₒ must equal the vertical panel to panel distance Dᵥ for each panel. By way of example, FIG. 9a shows central panel P_{C} and two side panels Pₓ and P_{y}. The closest panel Pₓ, has offset distance Dₒ=d and vertical panel to panel distance Dᵥ=b. In order for direct mating between the edge Eₓ of panel Pₓ and the edge E_{C1} of central panel P_{C} to occur when deployed, the following must be true b=d. Similarly, for panel P_{y}, which has offset distance Dₒ=c and vertical panel to panel distance Dᵥ=a. In order for direct mating between the edge E_{y} of panel P_{y} and the edge E_{C2} of central panel P_{C} to occur when deployed, the following must be true a=c.

FIGS. 9b to 9k provide various views of a panel stowage sequence for a deployed offset reflector stack.

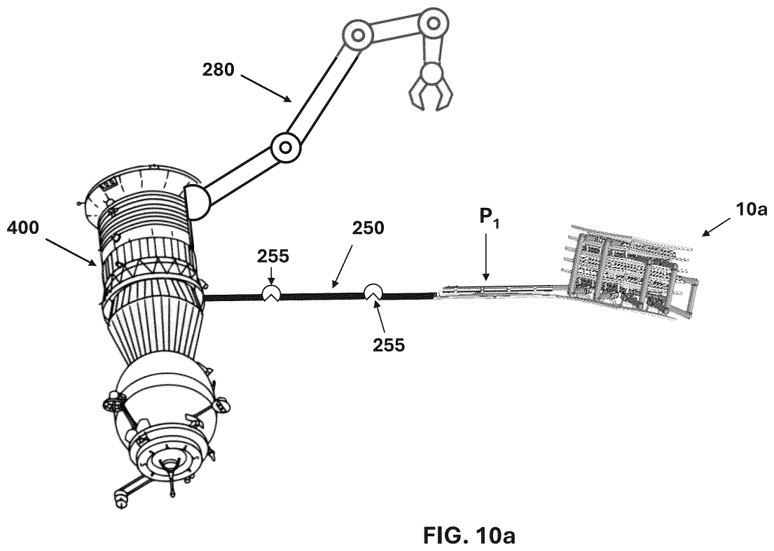

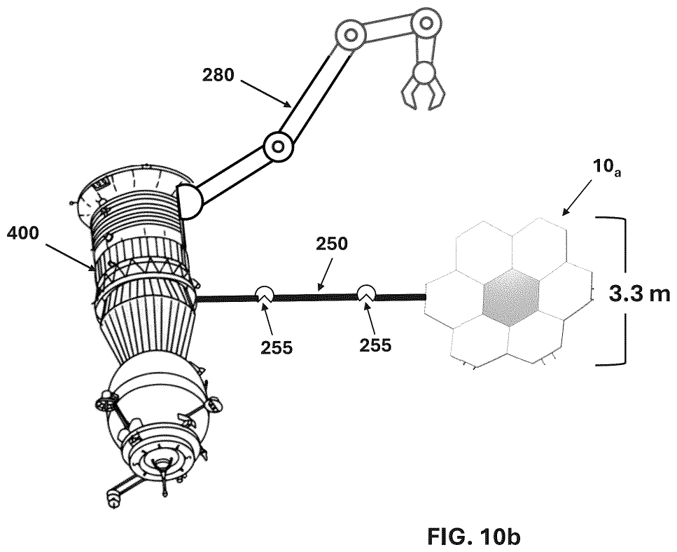

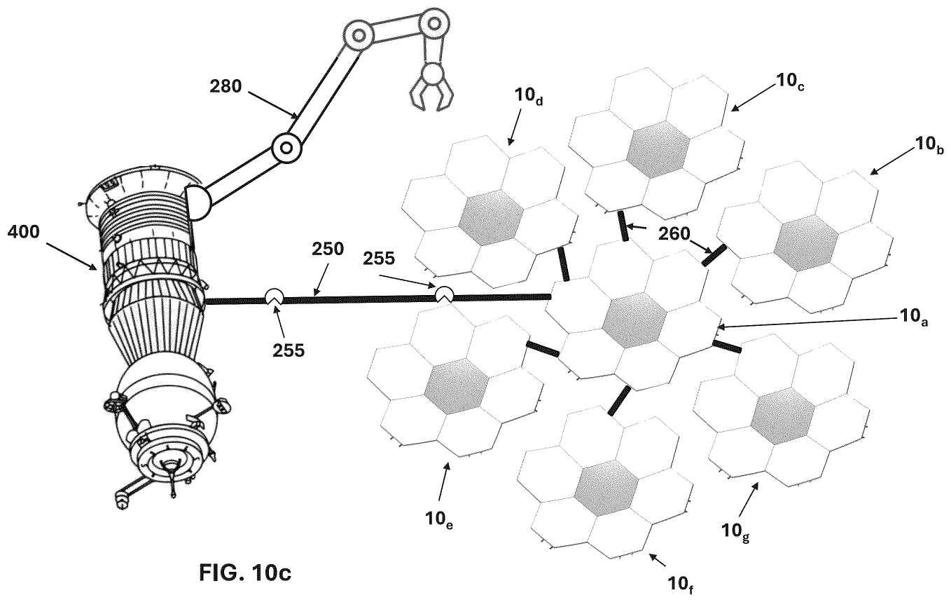

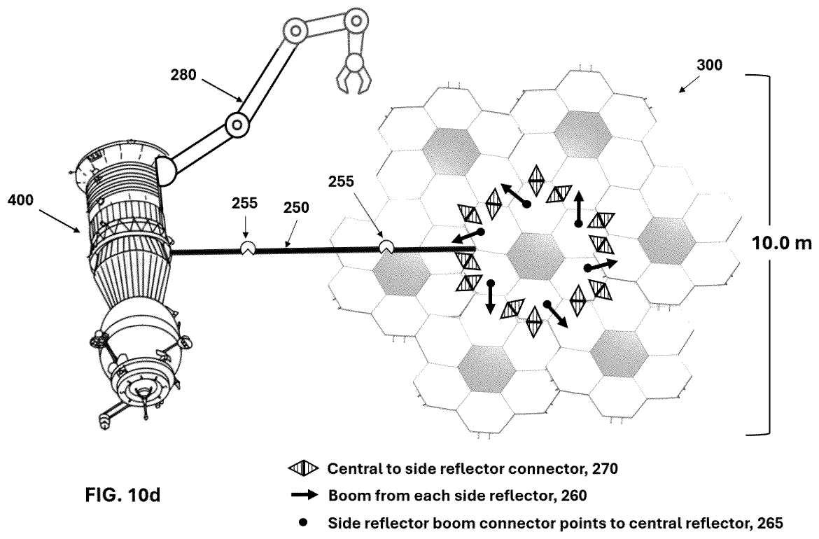

FIGS. 10a, 10b, 10c and 10d illustrate how the reflectors described above are central to a scalable architecture design which uses a combination of deployable and robotic-arm in-space assembly to construct a larger reflector. Referring to FIG. 10a, the outermost side panel, e.g., P₁ from stacked configurations above (furthest from the central one) will connect to the main spacecraft boom 250 having hinges 255, which is anchored from the spacecraft 400. As this side panel deploys first, the stacked reflector sub-array 10ₐ will be displaced from the spacecraft and the rest of the side panels will deploy one at a time triggered by activate hinges, e.g., the thermally actuated SMC hinges described above, resulting in a fully deployed reflector sub-array 10ₐ as shown in FIG. 10b.

In FIG. 10c, this first deployed sub-reflector 10ₐ can become the central reflector sub-array in a larger reflector by connecting to additional deployed reflector sub-arrays 10_{b}, 10_{c}, 10_{d}, 10ₑ, 10_{f}, and 10_{g} via their individual booms 260 to contact points 265 on the central reflector sub-array 10ₐ and other robotically connected assembly plates 270 as shown in FIG. 10d. Robotic arm 280 may be used to facilitate connections and placing of assembly plates described herein.

Referring to FIG. 10d, the final larger reflector 300 is the series of high-precision reflector sub-arrays 10_{b}, 10_{c}, 10_{d}, 10ₑ, 10_{f}, and 10_{g}, each cantilevered from a small offset boom 260 that a robotic arm attached to the spacecraft 400 uses to place and fix to the main central deployable reflector sub-array 10ₐ already supported from the main spacecraft boom 250, as shown in FIG. 10a. To increase the number of load paths through each reflector sub-array and increase global deployed stiffness, rigid interconnect assembly plates 270 can be used. This architecture does not require a robotic arm much longer than the size of the central reflector sub-array in order to keep cost down as the system scales up since the robotic arm is one of the main cost drivers. Robotic arm 280 is not shown to scale.

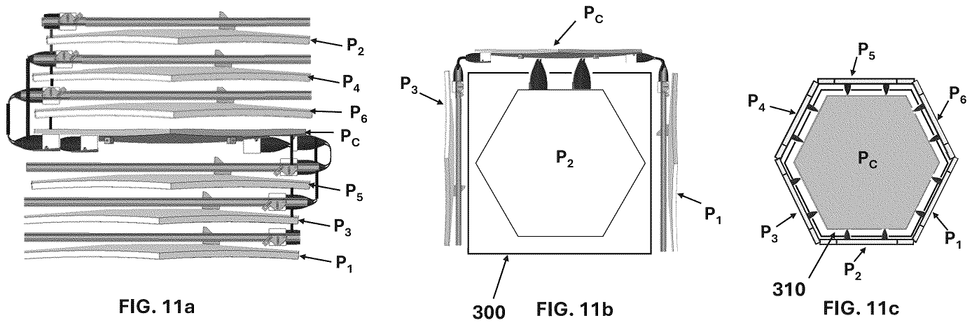

One skilled in the art will recognize that panel stacking configurations described above are not limited to the configurations shown. For example, FIGS. 11a, 11b and 11c illustrate alternative configurations to the panel stacking configuration of FIG. 1. In FIG. 11a, panels are stacked below (P₁, P₃, P₅) and above (P₂, P₄, P₆) the central panel P_{C}. In this configuration, some panels may be deployed at the same time, e.g., P₁ and P₂, P₃ and P₄, and P₅ and P₆. It will be appreciated that the number of panels below and above need not be the same. In FIG. 11b, panels P₁, P₂, P₃, P₄ (not shown) need not be stacked vertically, but could be stowed around the natural sides of a cube-type satellite 300. In this configuration, hinges H₁, H₂, H₃, H₄ (not shown), need only deploy 90 degrees (versus the 180 degrees in the stacked configurations). In FIG. 11c, which is showing a top view facing central panel P_{C}, panels P₁ thru P₆, are stowed around the natural sides of an hexagonal-type satellite 310. In this configuration hinges H₁ thru H₆ need only deploy 90 degrees.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the features of the embodiments and does not pose a limitation on the scope of the embodiments unless otherwise claimed. No language in the specification should be construed as indicating any non-claimed element as essential to the practice of the embodiments.

Preferred embodiments are described herein. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, these embodiments include all modifications and equivalents of the subject matter recited in the claims appended hereto as permitted by applicable law. Moreover, any combination of the above-described elements in all possible variations thereof is encompassed by the embodiments unless otherwise indicated herein or otherwise clearly contradicted by context.

1. An antenna reflector array having at least a stowed position and a deployed position, the array comprising:
multiple panels and a central panel, each of the multiple and central panels including a functional side and a non-functional side, wherein in the stowed position, the multiple and central panels are in a stacked configuration;
at least one heat actuated flexible hinge, each of the at least one flexible hinges being connected at a first end thereof to a non-functional side of one of the multiple panels and at a second end thereof to the non-functional side of the central panel, the heat actuated flexible hinges being controllable between a first shape and a second shape, and further wherein, when at least one of the heat actuated flexible hinges changes from the first shape to the second shape, the multiple panels connected thereto are moved from a first position to a second position; and
multiple closing mechanisms, each of the multiple closing mechanisms being movably attached to at least one of the heat actuated flexible hinges and an associated one of the multiple panels, wherein each of the multiple closing mechanisms is triggered when its associated panel is in the second position, the multiple closing mechanisms moving its associated panel to a third position responsive to the trigger, the third position resulting in the final deployed position.

2. An antenna reflector array of claim 1, wherein each of the multiple closing mechanisms comprises:
a trolley having a trigger mechanism, an actuator and a pair of end fittings attached to an end of each of the at least one heat actuated flexible hinges;
a set of rails for translating the trolley, including the at least one heat actuated flexible hinge attached to the associated one of the multiple panels, and therefore moving the associated one of the multiple panels to the third position; and panel mating components to accurately align, contact, and secure each of the multiple panels to the central panel.

3. An antenna reflector array of claim 2, wherein the trigger mechanism is a Frangibolt or a pin puller, the actuator is selected from the group consisting of a linear spring or a constant force lanyard reel for translating the trolley and providing a preload to the assembled panels, and the panel mating components are selected from the group consisting of a cup and cone or a ball and V-groove.

4. The antenna reflector array of claim 1, wherein each of the at least one flexible hinge includes a controllable heater for providing heat to the at least one heat actuated flexible hinge to actuate the heat actuated flexible hinge between the first and second shapes.

5. The antenna reflector array of claim 1, wherein each of the heat actuated flexible hinges is tubular.

6. The antenna reflector array of claim 1, wherein each of the multiple panels and the central panel are a rigid construction.

7. The antenna reflector array of claim 1, wherein the at least one of the heat actuated flexible hinges includes a hinge having a single hinge point and the remaining of the heat actuated flexible hinges include hinges having dual hinge points.

8. The antenna reflector array of claim 1, wherein in the stacked configuration the functional side of the central panel faces away from the non-functional sides of the multiple panels.

9. The antenna reflector array of claim 8, wherein the functional side of each of the multiple and central panels is curved; and
wherein when in the stacked configuration the curved functional side of the central panel faces an opposite direction from the curved functional sides of the multiple panels and when in the deployed position the curved functional side of the central panel faces a same direction as the curved functional sides of the multiple panels.

10. The antenna reflector array of claim 9, wherein the curved functional side of each of the multiple and central panels is a single curve; and
further wherein when in the deployed position, the antenna reflector array is cylindrical.

11. The antenna reflector array of claim 9, wherein the curved functional side of each of the multiple and central panels is a double curve; and
further wherein when in the deployed position the antenna reflector array is a surface of revolution such as a paraboloid.

12. The antenna reflector array of claim 8, wherein the functional side of each of the multiple and central panels is flat; and
further wherein when in the deployed position the antenna reflector array is flat.

13. The antenna reflector array of claim 8, wherein when in the stacked configuration, all of the multiple panels are stacked below the central panel and deployment of the multiple panels occurs from the outermost panel in the stack to the innermost panel in the stack with respect to the central panel.

14. The antenna reflector array of claim 8, wherein when in the stacked configuration, at least one of the multiple panels is stacked above the central panel and remaining multiple panels are stacked below the central panel.

15. The antenna reflector array of claim 8, wherein when in the stacked configuration, each of the multiple panels is concentrically aligned with the central panel.

16. The antenna reflector array of claim 8, wherein when in the stacked configuration, the stack is staggered and a first edge of each of the multiple panels is offset a distance Dₒ from a first edge of the central panel and the offset distance Dₒ is different for each of the multiple panels.

17. The antenna reflector array of claim 16, wherein the offset distance Dₒ for each of the multiple panels is equal to a vertical distance Dᵥ between each of the multiple panels and the central panel in the stack.

18. The antenna reflector array of claim 1, wherein when in the stacked configuration, each of the multiple panels is held at an approximately 90 degree angle to the central panel by the at least one of the heat actuated flexible hinges.

19. The antenna reflector array of claim 1, wherein the at least one heat actuated hinge is formed of a shape memory composite (“SMC”) substrate.
